(19) United States
(12) Patent Application Publication
(10) Pub. No.: US 2003/0091795 A1
(43) Pub. Date: May 15, 2003

(54) Metal flake-surfaced roofing materials

(76) Inventors: Matti Kiik, Richardson, TX (US); Michael L. Bryson, Blue Springs, MO (US); Margie A. Beerer, Ennis, TX (US)

Correspondence Address: BAKER & BOTTS, 30 ROCKEFELLER PLAZA, NEW YORK, NY, 10112

(21) Appl. No.: 10/274,717

(22) Filed: Oct. 21, 2002

Related U.S. Application Data
(63) Continuation-in-part of application No. 10/210,501, filed on Aug. 1, 2002.
Application No. 10/210,501 is a continuation of application No. 09/590,222, filed on Jun. 8, 2000, now abandoned.

(51) Int. Cl. B32B 1/00; D06N 7/04

(52) U.S. Cl. 428/148

(57) ABSTRACT

The present invention relates to roofing materials for roofs, sidewalls and other exterior surfaces exposed to the weather such as, but not limited to, asphaltic and non-asphaltic roofing materials, wherein metal flakes cover up to 100% of the weathering surface of the roofing materials. The metal flakes may be applied to the surface in striations or bands separated by conventional roofing granules or may be blended with conventional roofing granules. The metal flakes may have antimicrobial potential and may provide resistance to microbial growth to roofing materials when dispersed in or applied thereto. The present invention also relates to methods of making the roofing materials.

### SPECIFICATION

This application is a continuation-in-part of U.S. patent application Ser. No. 10/210501, filed on Aug. 1, 2002, which is a continuation of U.S. patent application Ser. No. 09/590,222, filed on Jun. 8, 2000, now abandoned.

### FIELD OF THE INVENTION

The present invention relates to metal flake-surfaced roofing materials which may be used for roofs and also for sidewalls and other exterior surfaces exposed to the weather. The roofing materials which may be surfaced with metal flakes include, but are not limited to, asphaltic roofing materials and non-asphaltic roofing materials such as concrete, plastic, rubber or metal roofing materials that have other materials on the exposed surface to provide a weathering surface or which are used for aesthetic purposes. The present invention further relates to methods of making the metal flake-surfaced roofing materials. Metal flakes may be applied to the surface of roofing materials as the sole surfacing material or in combination with typical colored roofing granules. Any roofing material that uses colored roofing granules, crushed natural stone, or coatings on the exposed roofing surface can have metal flakes applied thereto, in place of or in addition to the roofing granules, crushed natural stone, or coatings, in accordance with the present invention.

### BACKGROUND OF THE INVENTION

Roofing materials, such as roofing shingles, are made from a wide variety of materials, including metal, slate, concrete, plastic, asphalt, etc. Asphalt roofing materials have the advantages of good performance in extreme temperatures and areas where wind, water and ice are of concern. In addition, asphalt roofing materials offer enhanced efficiency in that they can be produced in high volume and can be easily installed, resulting in lower costs and improved overall value. Furthermore, asphalt roofs require little upkeep and are easily repaired when damaged. However, many asphalt roofing materials do not have the same aesthetic qualities as metal and slate roofs and most do not have the equivalent life span. Moreover, asphalt shingles, as well as certain non-asphaltic shingles, such as concrete shingles and plastic shingles, are prone to microbial growth staining.

To address the problem of microbial growth staining, non-metal roofing material manufacturers have offered several types of microbial resistant products, many of which incorporate antimicrobial agents such as metal ions to inhibit microbial growth staining.

For instance, antimicrobial agents have been mixed with the granules which surface certain asphaltic roofing materials. U.S. Pat. No. 5,573,810 and U.S. Pat. No. 5,356,664 describe copper containing algae resistant roofing granules which may be applied to the surface of an asphalt roofing material together with non-algae resistant granules. U.S. Pat. No. 4,092,441 describes metal algaecides which are sprayed in the form of droplets of molten metal onto the surface of roofing granules. The metal, which may be zinc, copper and/or other metal algaecides, inhibits microbial growth.

In addition, U.S. Pat. No. 5,599,586 describes the application of antimicrobial agents in the form of a polymer film, with improved weatherability, to the surface of roofing materials. Similarly, U.S. Pat. No. 3,932,143 discloses flame-spraying a first layer of metal on at least one side of a shingle and flame-spraying a second layer of copper on the first layer.

U.S. patent application Ser. No. 09/590,222 also discloses a surface covering building material including a component having antimicrobial potential to resist microbial growth-induced staining of the material. The component having antimicrobial potential consists essentially of (a) a copper component selected from the group consisting of copper powder and copper flakes and (b) a barium metaborate monohydrate component.

U.S. Pat. No. 2,133,988 describes a method of increasing shingle durability by using very fine aluminum flakes on the shingle surface between the larger mineral surfacing rock to block ultraviolet degradation of the asphalt coating and to lower the temperature of the shingle, thereby promoting asphalt stability and preventing blistering. U.S. Pat. No. 2,332,219 describes mixing the aluminum flakes with other materials to reduce dust, increase asphalt compatibility for reflowing the aluminum to the surface, and aid in adhering the aluminum flakes. The aluminum flakes may be used as the sole shingle covering or may be blended with mineral surfacing. The aluminum flakes may be adhered to other mineral rock granules and aluminum dross may be used as a granule or surface granule in whole or in part. The size of the flakes ranges between 150 and 350 mesh.

U.S. Pat. No. 4,617,198 discloses a metal chip application equipment for low slope applications. A water bath is used to cool a modified cap sheet and the chips are projected or flung onto the sheet. Chip materials include aluminum, magnesium and tin. The chips are rectangular chips having a size ranging from 10 to 200 mils on a side, preferably 60 to 80 mils on a side, by 1 to 2 mils thick. The patent also discloses that chips having a larger size than 200 mils on a side are not suitable due to their inability to withstand wind gusts when the cap sheet having the metal chips is applied on a roof.

Metal and slate roofing materials generally do not have the problem of microbial growth staining. The advantages of metal roofs are that they are aesthetically pleasing, durable, long lasting, lightweight, ecologically sound, fire retardant, and energy efficient. The disadvantages of metal roofs are that they are expensive, require installation by a professional trained in metal roofing installation, and can be damaged or dented by outdoor elements, such as hail. Tegola (Pasiano, Italy) manufactures a copper foil shingle which is an asphalt strip shingle that has a copper foil over the exposed portion of the shingle. The copper foil-asphalt strip shingle is easier to install than conventional metal shingles.

Slate roofs have the advantages of long life, fire resistance, high strength, low maintenance, and an aesthetically distinctive appearance. Slate roofs, however, are heavy and expensive. Further, slate exists in limited color choices, requires frequent maintenance, can be easily damaged (particularly during maintenance due to walking on the roof), and relies on underlayment which usually fails before the slate.

Accordingly, there exists a need for a roofing material with improved durability and aesthetic qualities. There is also a need for a roofing material which has an appearance of a metal or slate shingle but which does not have the expense, manufacturing, weight, leakage or maintenance problems associated with such shingles, and which is easily installed.

### SUMMARY OF THE INVENTION

The present invention is a metal flake-surfaced roofing material comprising a headlap and a weathering surface, wherein the weathering surface comprises metal flakes and the headlap is substantially free of metal flakes, wherein the metal flakes cover greater than 0.001% and up to 100% of the weathering surface. Roofing materials that may be surfaced with metal flakes in accordance with the invention include, but are not limited to, asphaltic roofing materials, non-asphaltic roofing materials (such as concrete, rubber and plastic materials) and other exterior cladding building materials. The metal flake-surfaced roofing materials of the present invention provide the advantages of metal shingles and the water proofing and easy installation of asphalt shingles. In addition, metal flake-surfaced roofing shingles have an improved appearance and durability. Further, the metal flake-surfaced roofing materials of the present invention may exhibit resistance to microbial growth-induced staining thereon. Moreover, the flakes may be made using recycled metal, so that the use of metal flakes to cover an asphaltic shingle with the flakes is cheaper than conventional metal sheet roofing. Furthermore, the metal flake-surfaced roofing materials are less expensive on an installed basis than conventional metal shingles, such as copper shingles or tin shingles, and can be manufactured by the same production process as used, for example, for asphaltic shingles. In particular, labor costs for the installation of the roofing materials of the present invention are up to three times lower than the costs required for the installation of metal or slate shingles.

The roofing materials of the present invention, whether asphaltic or non-asphaltic, include flakes of metal dispersed on the surface of the roofing material.

In one embodiment of the invention, where the roofing material is an asphaltic composite, such as an asphalt roofing shingle, the metal flakes are dispersed on the surface of the shingle intended for weather exposure, or “weathering surface,” so as to cover the entire area or nearly the entire area of that surface. In another embodiment of the present invention, the metal flakes are applied to the weathering surface of the shingle, or a portion thereof such as the backer strip of a laminated shingle, in bands or striations which are separated by regions whereon standard roofing granules have been applied. In a further embodiment of the present invention, the metal flakes are applied to the weathering surface of the shingle such that the surface of the shingle is covered by approximately equal amounts of metal flakes and standard roofing granules.

The present invention also provides a method of making the metal flake-surfaced roofing material comprising heating the metal flakes prior to or after application of the flakes to the roofing material.

### BRIEF DESCRIPTION OF THE DRAWINGS

The present invention may be better understood with reference to the attached drawings in which

FIG. 1 shows an exemplary embodiment of a metal flake-surfaced roofing shingle according to the present invention, where nearly the entire weathering surface of the shingle has been covered with metal flakes.

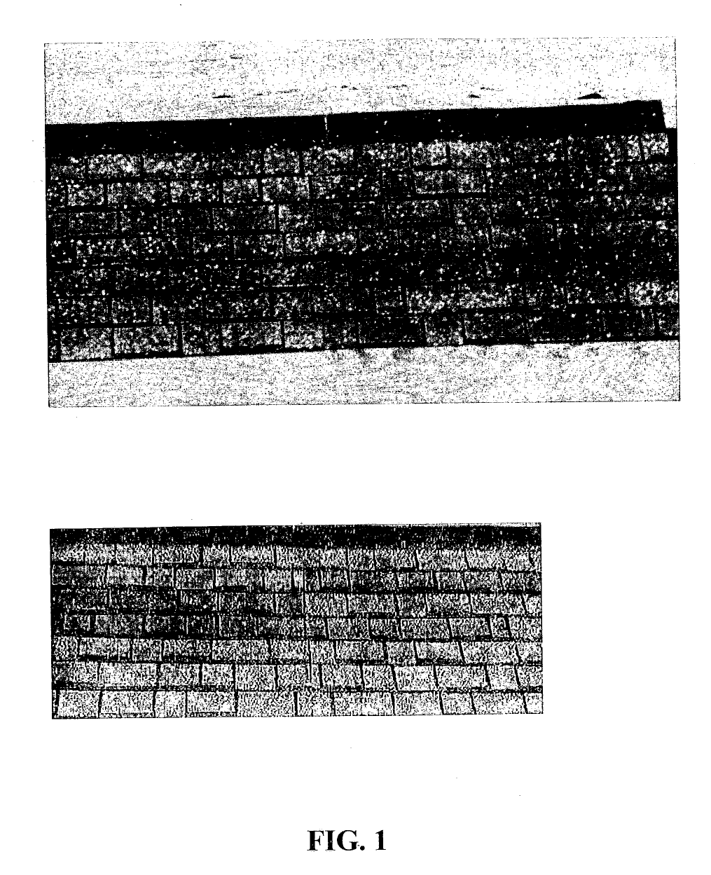

### DETAILED DESCRIPTION

This invention is not limited to any particular roofing material and may comprise surfacing a wide variety of such materials with metal flakes, including asphaltic and non-asphaltic roofing materials. Representative examples of such roofing materials include, inter alia, those roofing materials described in U.S. Pat. Nos. 3,886,021; 4,082,885; 4,405,680; 4,468,430; 5,305,569; 5,565,239; 5,666,776 and 5,743,985 which are incorporated herein by reference. The roofing materials may be in various forms including, for example, asphalt roofing shingles, non-asphaltic roofing shingles, roofing tiles, roll roofing, commercial cap sheets, modified bitumen cap sheets, shakes and sidewalls.

As used herein, the term “weathering surface” does not include the headlap of the roofing shingle. Accordingly, the metal flakes are applied so as to cover the entire area or nearly the entire area of the weathering surface, while the headlap of the roofing shingle remains substantially free of metal flakes.

The metal flakes may be applied to the roofing materials by any method known in the art. For example the metal flakes may be applied in a similar manner as roofing granules are applied to an asphaltic roofing shingle, i.e. the metal flakes may be applied to an asphaltic shingle during the asphalt shingle making process while the asphalt is still hot. In addition, the metal flakes may be heated and then applied to a surface of an asphaltic roofing material in order to adhere the metal flakes to the surface of the roofing material. Alternatively, the metal flakes may be applied to the surface of a roofing material and then heated to ensure that the metal flakes are adhered to the surface of the roofing material. The metal flakes are preferably applied to the weathering surface so that the metal flakes do not substantially overlap when the roofing material of the present invention is applied to a roof.

Stone coated metal shingles use an acrylic coating to adhere colored roofing granules to the metal. This process may be used in accordance with the present invention to apply metal flakes to any roofing material. For example, copper flakes may be applied to a steel shingle by such a process. The application of copper flakes to a thin steel shingle may result in a shingle that is thinner and lighter than conventional copper shingles but still retains the desired characteristics of conventional copper shingles.

Flex Shake™ (US Century, California) is a roofing product made from used tires (recycled steel reinforced rubber). An adhesive coating is applied to the surface of the rubber for the application of slate chips or colored roofing granules. In accordance with the present invention, metal flakes may be correspondingly applied to the surface of the rubber using an adhesive coating.

The metal flakes may be of any metal. Nonlimiting examples include copper, tin, zinc, aluminum, brass, bronze, steel, stainless steel, lead, or any other desired metal. The metal flakes may be made from recycled metal to lower the cost of the roofing material. Moreover, the metal flakes may be coated, preferably with ceramic paints, to achieve any desired aesthetic appearance, such as an appearance of any metal or stone. The metal flakes need not contain barium metaborate monohydrate.

The metal flakes may be interspersed with conventional roofing granules (e.g. colored roofing granules) to provide unique aesthetic appearances. For example, the interspersement of metal flakes and roofing granules may produce the appearance of bands or striations to achieve aesthetic characteristics, such as to enhance the ability of the resultant shingle to provide a perception of depth to the roof.

In another embodiment of the present invention, asphaltic roofing materials are covered with metal flakes and standard roofing granules in approximately equal amounts. The flakes dispersed on the shingle may provide resistance to microbial growth by remaining present during the weathering of the material. For example, where the roofing material of the present invention is an asphaltic composite, such as an asphalt roofing shingle, copper flakes may be added to and dispersed throughout the filled asphalt portion of the building material to produce a shingle resistant to microbial growth staining. In addition, copper flakes may be added to any portion of the roofing materials of the present invention, including the entire material to produce a shingle resistant to microbial growth staining. Any metal capable of inhibiting microbial growth may be used to produce a shingle resistant to microbial growth staining, as herein indicated.

As used herein, resistance to microbial growth-induced staining refers to resistance to such staining during the weathering of the roofing material for the normal life of the material (i.e. from about one to fifty years).

The filled portion of the roofing material, as used herein, refers to any portion of a roofing material including a filler material known in the art including, inter alia, filler materials described in U.S. Pat. No. 5,965,257; U.S. Pat. No. 5,391,417 and U.S. Pat. No. 4,405,680, which are incorporated herein by reference.

In addition, the roofing material of the present invention may be non-asphaltic, such as, but not limited to, cement tile and composite imitation slate, and is surfaced with metal flakes to produce the metal flake-surfaced roofing materials of the present invention. Alternatively, the non-asphaltic roofing material may include metal flakes having antimicrobial potential dispersed throughout any portion, including the entirety, of the nonasphaltic building material.

The roofing material may be a bitumen cap sheet and the metal flakes may be applied onto the bitumen cap by laying the flakes flat on the sheet.

The metal flakes may have antimicrobial potential, i.e. they are capable of conferring resistance to microbial growth. Any suitable metal flakes having antimicrobial potential capable of withstanding the processing temperatures involved in making the asphaltic or non-asphaltic roofing materials may be employed in accordance with the present invention. In a preferred embodiment, the antimicrobial metal flake is copper flake. More than one type of metal flake may be used in accordance with the present invention. For example, copper flakes and tin flakes may be used to achieve a particular aesthetic or antimicrobial effect.

The metal flakes having antimicrobial potential preferably inhibit the growth of cyanobacterium, which is a microbe often responsible for microbial fouling of roofing materials. The metal flakes preferably withstand high heat, mixing and abrasion without significantly losing their antimicrobial properties.

The metal flake-surfaced roofing materials of the present invention provide a durable and aesthetically pleasing roofing material and have an improved life compared to conventional roofing materials. In a preferred embodiment, the metal flake-surfaced roofing materials have a life of greater than 40 years when used on a roof. In a particularly preferred embodiment, they have a life of greater than 50 years when used on a roof. Additionally, roofs covered with the metal flake materials of the present invention demonstrate greater light (solar) reflectivity (i.e., the energy repulsion of a “cool roof”) and enhanced hail impact resistance. Thus, utilization of the materials of the present invention affords many of the benefits of slate roofs without the added weight and cost and complexity of installation. Metal flakes may be less than half the thickness of the same metal used in conventional metal shingles. For example, copper shingles can measure 0.025″ in thickness and metal flakes can average 0.007″ in thickness.

The metal flake-surfaced roofing materials can have an appearance, for example, of a metal roof (such as a copper roof), or a slate roof. When tin flakes are employed, the roof may have an appearance of a tin roof. In a preferred embodiment, the roofing material of the present invention is a copper flake-surfaced roofing material. When the copper flakes oxidize from exposure to the elements, they turn various colors. As copper ages from its original bright shine it goes through brown or bronze tones and then ultimately to its renowned green patina. When the copper flake-surfaced roofing material of the present invention achieves the green patina, the roofing material may resemble a slate roof. The coverage of an asphalt roofing material with metal flakes according to the present invention can produce a roofing material with the benefits of both asphaltic roofing materials and metal roofing materials. The resultant roofing material (asphalt shingle surfaced with metal flakes, such as copper flakes) is durable, aesthetically pleasing, relatively inexpensive, easy to install, low maintenance, long lasting and may be further resistant to microbial growth staining. Coating of the metal flakes, for example with ceramic paints, may achieve any desired aesthetic appearance.

Additionally, the metal flake-surfaced roofing materials of the present invention may provide architectural qualities, e.g. a roof surfaced with them does not look flat but rather has a three-dimensional architectural look. Furthermore, architectural qualities are imparted to the metal flake-surfaced roofing materials by applying the metal flakes in striations or bands which are separated by conventional roofing granules, such as ceramic roofing granules, or by blending the metal flakes with roofing granules. The interspersement and/or blending of the metal flakes and roofing granules allow the roofing materials of the present invention to impart to a roof a more three-dimensional appearance. In addition, different metal flakes (e.g., tin and copper / steel and bronze) may be blended together to achieve unique aesthetic appearances and may also be blended with roofing granules.

In a preferred embodiment, the metal flake-surfaced roofing material of the present invention comprises from about 20 lbs. to about 70 lbs. of metal flakes per 100 square feet of roofing material. In a particularly preferred embodiment, the metal flake surfaced roofing material of the present invention comprises from about 45 lbs. to about 65 lbs. copper flakes having a thickness of about 0.07″ to about 0.018″ per 100 square feet of asphalt shingle. In another preferred embodiment, the metal flake-surfaced roofing shingle of the present invention comprises from about 25 lbs. to about 50 lbs. copper flakes having a thickness of about 0.006″ to about 0.011″ per 100 square feet of asphalt shingle. In another embodiment, the metal flake-surfaced roofing shingle of the present invention comprises aluminum flakes having a thickness of at least about 0.012″. The thickness of the metal flakes is such that the metal flakes do not ignite when subjected to UL 790 or ASTME-108 Class A fire testing. Accordingly, the amount of metal flakes per 100 square feet of roofing material may vary considerably and depends on the metal density, metal thickness, size distribution and desired aesthetic appearance. The metal flakes are preferably greater than flakes having a size passing through a U.S. Standard Sieve #50. For example, the metal flakes can range in size from passing through a U.S. Standard Sieve #50 up to 1″ in size. The metal flakes may be obtained from Fisher Scientific, of Pittsburgh, Pa. The thickness may range from about 0.001″ to about 0.0125″. In one embodiment, the thickness of copper flakes may be from about 0.007″ to about 0.012″. The sieve analysis for copper flakes having an average thickness of 0.0079″±0.0010″ (using U.S. Standard Sieve) is shown in Table I below:

TABLE 1

| Sieve | Copper Flake |
|---|---|
| +8 | 11.8% |
| +12 | 20.5% |
| +16 | 48.1% |
| +20 | 18.3% |
| −20 | <1.3% |

The roofing materials of the present invention have advance UL 790 or ASTME-108 Class A fire classifications for asphalt fiberglass shingles. Other shingles that have weathering surfaces comprising metal flakes retain their fire ratings. A preferred method for making the metal flake-surfaced roofing materials of the present invention comprises adding the metal flakes to the roofing material during the roofing material making process, wherein the metal flakes are affixed to the surface of the roofing material. For example, the metal flakes may be applied to an asphaltic roofing material while the roofing material is still hot and not yet solidified, whereby the metal flakes are affixed to a surface of the asphaltic roofing material. In another embodiment, hot metal flakes are applied to the surface of a roofing material, whether asphaltic or non-asphaltic, such that the metal flakes are affixed to the roofing material. Alternatively, the metal flakes may be applied to the surface and heated after application to the surface, such that the metal flakes are affixed to the roofing material.

In one embodiment of the present invention, the metal flakes are of similar size to conventional roofing granules. In such an embodiment, the process of applying the metal flakes to a roofing material may be similar to the process of applying conventional roofing granules to a roofing material. In contrast, known metal roofing processes involve sheet or coil metal and the shingles are formed by stamping, bending or punching which is cumbersome. In addition, known metal roofing processes require special shingle cutting equipment.

When the metal flakes are to be included in a filled portion of a material, the metal flakes may be dispersed throughout the filled portion during the roofing material making process. The metal flakes so dispersed may provide resistance to microbial growth by remaining present during the weathering of the roofing material. The metal flakes having antimicrobial potential that are added to the filled portion during the roofing material manufacturing process must retain their antimicrobial potential during the heat of processing of the material which ranges from about 50 ° C. to about 500 ° C. The metal flakes included in a filled portion of the material are preferably smaller than the metal flakes covering the weathering surface, ranging in size between mesh size 40 and mesh size 200.

The invention is further illustrated by reference to the following examples.

### EXAMPLES

### Example 1

Preparation of Copper Flake-surfaced Asphaltic Roofing Material:

A line trial was conducted in which 5 1/2 bundles of shingles were made with full copper flake coverage. The copper was applied to asphalt shingles according to methods known in the art for applying roofing granules to asphalt shingles during the asphalt shingle making process. The copper flake coverage, loading and adhesion to the asphalt shingles was very good. Table II below summarizes the data for a copper flake-surfaced shingle made in accordance with the invention:

TABLE II

| | Regular Colored | | |
|---|---|---|---|
| | Granite Shingles | Trial Copper Shingles | |
| | Run Average | Run Average | |
| | (pounds) | (pounds) | Difference |
| Square weight | 279 | 316 | +37 |
| Top Coating | 53.3 | 83.5 | +30.2 |
| Rubloss | 0.24 | 0.35 | |
| Butt Granule | 28.2 | 65.2 | +37 |

The shingles described in Table II were laminated shingles like those illustrated in U.S. Pat. No. Des. 369,421 having a backstrip with black colored granules. The exposed portion of the top layer of the shingles was entirely covered with copper flakes. The copper flakes were in the form of platelets supplied by OMG Americas, Research Triangle Park, North Carolina. The thickness of the copper flakes ranged from about 0.001″ to about 0.0125″.

The square weight increase appeared to be completely due to the copper. While the top coating showed only a 30 pound increase in the loading as compared to the 37 pound increase in the square weight, this was probably due to copper flakes spreading to the headlap in significant amounts.

Although the present invention has been described in detail with reference to specific exemplary embodiments thereof, various modifications, alterations and adaptations may be made by those skilled in the art without departing from the spirit and scope of the invention. It is intended that the invention be limited only by the appended claims.

We claim:

1. A roofing material comprising a headlap and a weathering surface, wherein the weathering surface comprises metal flakes and the headlap is substantially free of metal flakes, wherein the metal flakes cover greater than 0.001% and up to 100% of the weathering surface of the roofing material.

2. A roofing material comprising a headlap and a weathering surface, wherein the weathering surface comprises metal flakes and roofing granules and the headlap is substantially free of metal flakes, wherein the metal flakes cover greater than 0.01% of the surface of the roofing material.

3. The roofing material of claim 2, wherein striations of the metal flakes are separated by regions of the roofing granules.

4. The roofing material of claim 2, wherein the metal flakes are blended with the roofing granules.

5. The roofing material of claim 1, wherein the metal flakes are selected from the group consisting of copper flakes, tin flakes, zinc flakes, aluminum flakes, steel flakes, stainless steel flakes, bronze flakes, brass flakes and combinations thereof.

6. The roofing material of claim 1, wherein the metal flakes are copper flakes.

7. The roofing material of claim 1, wherein the metal flakes have antimicrobial potential.

8. The roofing material of claim 1, wherein the roofing material comprises a filled portion, and wherein the filled portion includes metal flakes.

9. The roofing material of claim 1, wherein the roofing material is made by a process comprising applying the metal flakes to the weathering surface of the roofing material.

10. The roofing material of claim 1, wherein the metal flakes are first heated and then applied to the weathering surface.

11. The roofing material of claim 1, wherein the metal flakes are first applied to [a] the weathering surface and then heated.

12. The roofing material of claim 1 wherein the roofing material is made by a process comprising dispersing the metal flakes throughout a portion of the roofing material.

13. The roofing material of claim 12 wherein the portion is a filled portion.

14. The roofing material of claim 1, wherein the metal flakes are dispersed throughout the material and are applied to the weathering surface of the material during the material making process.

15. The roofing material of claim 1 wherein the metal flakes are dispersed throughout a portion of the material and applied to the weathering surface of the material during the material making process.

16. The roofing material of claim 1 wherein the roofing material is an asphaltic roofing material.

17. The roofing material of claim 1, wherein the metal flakes are of a size greater than the size of flakes passing through a U.S. Standard Sieve #50.

18. The roofing material of claim 17, wherein the metal flakes range from a size greater than the size of flakes passing through a U.S. Standard Sieve #50 to 1″.
